(19) United States
(12) Patent Application Publication
(10) Pub. No.: US 2024/0426781 A1
(43) Pub. Date: Dec. 26, 2024

(54) DEVICE AND METHOD FOR DETECTING A SUB-SURFACE BTEX COMPONENT

(71) Applicants: TotalEnergies OneTech, COURBEVOIE (FR); Centre National de la recherche scientifique, PARIS (FR); UNIVERSITE DE FRANCHE-COMTE, BESANCON (FR); ECOLE NATIONALE SUPERIEURE DE MECANIQUE ET DES MICROTECHNIQUES, BESANÇON CEDEX (FR)

(72) Inventors: Anthony CREDOZ, Pau Cedex (FR); John-Richard ORDONEZ-VARELA, Paul Cedex (FR); Aurélie LE BEULZE, Pau Cedex (FR); Jean-Michel FRIEDT, Pau Cedex (FR); David RABUS, Pau Cedex (FR); Frédéric CHERIOUX, Pau Cedex (FR); Lilia ARAPAN, Pau Cedex (FR)

(73) Assignees: TotalEnergies OneTech, COURBEVOIE (FR); centre national de la recherche scientifique, PARIS (FR); UNIVERSITE DE FRANCHE-COMTE, BESANCON (FR); ECOLE NATIONALE SUPERIEURE DE MECANIQUE ET DES MICROTECHNIQUES, BESANÇON CEDEX (FR)

(21) Appl. No.: 18/690,485

(22) PCT Filed: Sep. 8, 2021
(86) PCT No.: PCT/IB2021/000637

§ 371 Date: Mar. 8, 2024

(51) Int. Cl. G01N 29/024; G01N 29/02; G01N 29/24; G01N 29/32

(52) U.S. Cl. CPC G01N 29/024; G01N 29/022; G01N 29/2462; G01N 29/2481; G01N 29/326; G01N 2291/0224; G01N 2291/0423

(57) ABSTRACT

A device for wireless detection of a BTEX component in a soil saturated with water, comprising an antenna, a permeable enclosure, and a sensor located in the enclosure. The sensor comprises:
a piezoelectric substrate comprising lithium tantalate,
an interdigitated transducer connected to the antenna for producing surface acoustic waves,
a first mirror for a first echo of the acoustic waves,
a second mirror for producing a second echo,
a first layer of a first polymer between the transducer and the second mirror, the first polymer being adapted for reacting with the BTEX component so as to modify a travel speed of the second echo, and
a first guiding layer comprising a metal and/or a polymer and located between the transducer and the first mirror.

### CROSS REFERENCE TO RELATED APPLICATION

The present application is a U.S. National Phase Application under 35 U.S.C. § 371 of International Patent Application No. PCT/IB2021/000637 filed Sep. 8, 2021. The entire contents of which are hereby incorporated by reference.

### FIELD OF THE INVENTION

The present invention deals with a device adapted for detecting a sub-surface BTEX component in a liquid phase, for example in a soil saturated with water.

The invention also deals with an installation including at least one such device, and with a method for detecting a sub-surface BTEX component in a liquid phase using such device.

### BACKGROUND

In the oil and petrochemical industries, BTEX refers to benzene, toluene, ethylbenzene, and xylene isomers, these aromatic hydrocarbons being considered alone or in mixtures. Detecting these chemical components is important for managing potentially contaminated soil and groundwater in and from industrial sites.

Today, existing solutions are directly deployed in monitoring wells, which have to be drilled. Occasionally, optical measurements (Infra-red) of BTEX are performed. However, these direct solutions are costly and may suffer calibration issues, and drift due to exposure to contaminants. Also, they may expose operators to the contaminants.

More traditional, indirect, solutions require sampling by pumping groundwater to the surface. The BTEX concentrations are then determined either on site using portable analyzers, or later in a laboratory remote from the industrial site. However, these solutions introduce a large delay between sampling and measuring, and a loss of contaminants may occur during the transport of samples.

To our knowledge, there exists no permanent solution for this type of detection. Of course, various techniques are known in order to detect all kinds of components, but none has been able to address the issue of detecting chemical components such as BTEX, in a liquid phase such as a water saturated soil, and wirelessly.

### SUMMARY

An aim of the invention is to solve or improve the above issues, in particular in order to allow permanent detection of BTEX components in a sub-surface liquid phase that is difficult to access.

To this end, the invention proposes a device for detecting a BTEX component in a soil saturated with water, the BTEX component and the water forming a liquid phase, the device comprising: an antenna adapted for receiving a radar signal and emitting a response radar signal; an enclosure permeable to the liquid phase; and a sensor located in the enclosure and comprising:
a piezoelectric substrate comprising lithium tantalate, the substrate having a surface extending in a longitudinal direction,
an interdigitated transducer located on the surface and electrically connected to the antenna for receiving an input electrical signal from the antenna and sending an output electrical signal to the antenna, the interdigitated transducer being adapted to convert the input electrical signal into surface acoustic waves in the longitudinal direction,
a first mirror located on the surface and adapted for receiving a first part of the surface acoustic waves and producing a first echo towards the interdigitated transducer by mechanical reflection and/or re-emission of said first part of the surface acoustic waves,
a second mirror located on the surface and adapted for receiving a second part of the surface acoustic waves and producing a second echo towards the transducer by mechanical reflection or re-emission of said second part of the surface acoustic waves,
at least a first layer of a first polymer located on the surface between the transducer and the second mirror, the first polymer being adapted for reacting with the BTEX component so as to modify a travel speed of the second echo along the first layer, and
at least a first guiding layer comprising a metal and/or a polymer, the first guiding layer being located on the surface between the transducer and the first mirror,
the interdigitated transducer being adapted to convert the first echo and the second echo into at least part of the output electrical signal,
the antenna being adapted for converting the output electrical signal into the response radar signal.

In other embodiments, the device comprises one or several of the following features, taken in isolation or any technically feasible combination:
a third mirror located on the surface and adapted for receiving a third part of the surface acoustic waves and producing a third echo towards the transducer by mechanical reflection and/or re-emission of said third part of the surface acoustic waves, the transducer being adapted for receiving the third echo and converting the third echo into at least part of the output electrical signal; and a second guiding layer comprising a metal and/or a polymer, the second guiding layer being located on the surface between the first mirror and the third mirror;
a fourth mirror located on the surface and adapted for receiving a fourth part of the surface acoustic waves and producing a fourth echo towards the transducer by mechanical reflection and/or re-emission of said a fourth part of the surface acoustic waves; and a second layer of a second polymer located on the surface between the transducer and the fourth mirror, said second polymer being distinct from the first polymer and adapted to react with a chemical component in said liquid phase so as to modify a travel speed of the fourth echo along said second layer,
the transducer being adapted for receiving the fourth echo and converting the fourth echo into at least part of the output electrical signal;
the sensor is configured so that said surface acoustic waves, first echo and second echo comprise Love waves;
the first polymer comprises poly (epichlorohydrin) or polyisobutene;
the device is devoid of any battery;
the transducer, the first mirror and the second mirror comprise aluminum;
one or several of the transducer, the first mirror and the second mirror are interdigitated transducer(s) having split-fingers extending in a transverse direction perpendicular to the longitudinal direction;
one or several of the transducer, the first mirror and the second mirror are interdigitated transducer(s) with sine shaped apodization;
the antenna is a broadband antenna;
the antenna has a spiral shape; and
said transducer is configured to produce the surface acoustic waves along the first layer of polymer with a given wavelength, and said first layer has a thickness perpendicularly to the longitudinal direction and the transverse direction, said thickness being comprised between 2% and 7% of said wavelength.

The invention deals with an installation comprising:
at least one device according to any one of claims intended to be buried in a soil at a distance from a surface of said soil; and
a system adapted for emitting said radar signal and for receiving said response radar signal, the system being intended to be above said soil.

In a particular embodiment, said system is configured so that said radar signal includes a number of sequential oscillations, said number being comprised between 8 and 12.

The invention also deals with a method for detecting a BTEX component in a soil saturated with water, the water and the BTEX component forming a liquid phase, comprising the following steps:
obtaining a device or an installation,
reception of a radar signal by the antenna and production of an input electrical signal,
reception by the transducer of the input electrical signal, and conversion of the input electrical signal into surface acoustic waves in the longitudinal direction,
reception by the first mirror of a first part of the surface acoustic waves and production of a first echo towards the interdigitated transducer by mechanical reflection and/or re-emission of said first part of the surface acoustic waves,
reception by the second mirror of a second part of the surface acoustic waves and production of a second echo towards the transducer by mechanical reflection or re-emission of said second part of the surface acoustic waves,
reaction of the first polymer with the BTEX component and modification of a travel speed of the second echo along the first layer,
conversion of the first echo and the second echo by the interdigitated transducer into at least part of an output electrical signal,
conversion by the antenna of the output electrical signal into a response radar signal, and
using the response radar signal in order to detect the BTEX component.

### BRIEF DESCRIPTION OF THE DRAWINGS

The invention and its advantages will be better understood upon reading the following description, given solely by way of example and with reference to the appended drawings, in which:

FIG. 1 is a schematic perspective view of an installation according to the invention,

FIG. 2 is a schematic front view of a sensor of the installation shown in FIG. 1,

FIG. 3 is a schematic front view of a pattern of the interdigitated transducer or the mirrors of the sensor shown in FIGS. 1 and 2

FIGS. 4 and 5 are schematic front views of two patterns forming variants of the pattern shown in FIG. 3,

FIG. 6 is a diagram showing the time response of the sensor to a pulse, depending on which of the three patterns shown in FIGS. 3 to 5 is used,

FIG. 7 is a diagram showing the time response of the sensor shown in FIGS. 1 and 2, with and without the first layer of polymer and the second layer of polymer,

FIG. 8 is a diagram showing a dispersion curve of a layer of polymer on the substrate of the sensor shown in FIGS. 1 and 2 versus the thickness of the layer, and

FIG. 9 is a diagram showing the delay, expressed as a phase difference, between the third echo and the first echo (serving as reference), the second echo and the first echo, and the fourth echo and the first echo.

### DETAILED DESCRIPTION

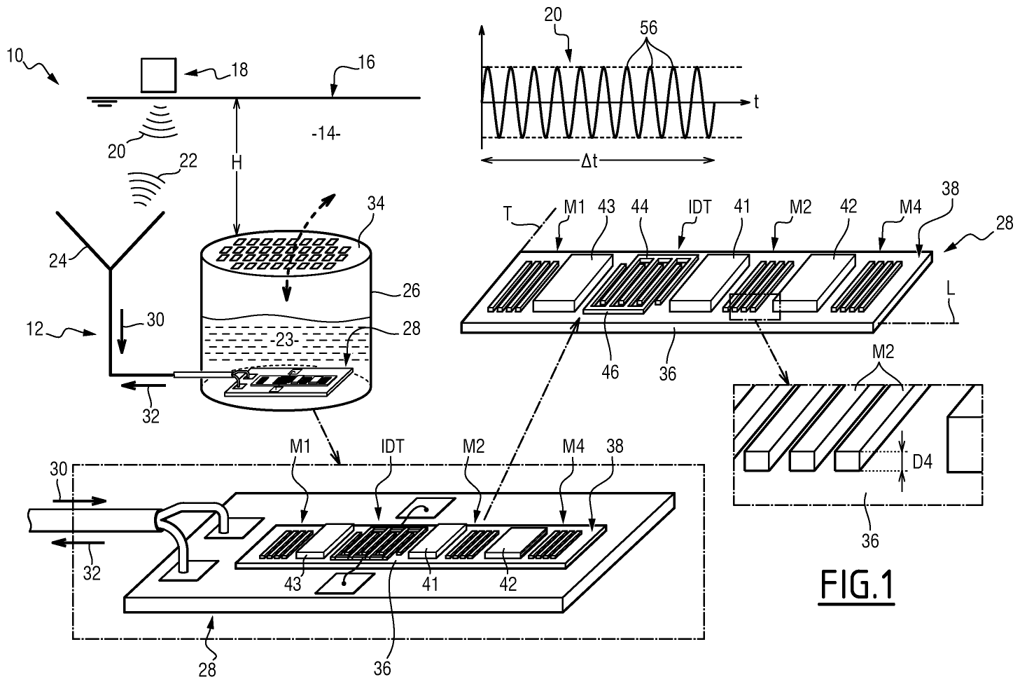

An installation 10 according to the invention will now be described with reference to FIG. 1.

The installation 10 comprise a device 12 according to the invention, buried in a soil 14 at a distance H from a surface 16 of said soil, and a system 18 located above said soil and adapted for emitting a radar signal 20 towards the device and for receiving a response radar signal 22 from the device.

As a variant (not shown), the installation 10 may comprise several devices analogous to the shown one, and/or several systems analogous to the shown system 18.

The soil 14 is for example saturated with water and contains a BTEX component, for example toluene, which is to be detected by the installation 10. The BTEX component is for example carried, or pushed, by the water present in the soil 14. It is assumed here that the BTEX component and water constitute a miscible or immiscible water-liquid phase 23. The word “phase” here does not mean that the BTEX component is miscible with the water.

In the example shown, the installation 10 is advantageously able to detect another chemical component, for example a BTEX one distinct from toluene, or for another analyte like, for instance, H₂S.

According to other variants, the installation 10 may be able to detect more than two distinct chemical components.

The distance H is for example comprised between 1 to 2 meters in temperate regions and up to 5 or 10 meters in dry regions (e.g. permafrost, desert).

By “detect a chemical component”, it is meant that the installation 10 is adapted to provide information showing the presence of said chemical component next to the device 12, preferably in quantitative or semi-quantitative manner.

The device 12 is meant to stay in the soil 14 and is adapted to send information via the response radar signal 22 when interrogated by the system 18. The device 12 is configured as a cooperative target to Ground Penetrating RADAR (known in itself as GPR).

The device 12 is advantageously wireless and devoid of any battery.

The device 12 comprises an antenna adapted 24 for receiving the radar signal 20 and emitting the response radar signal 22, an enclosure 26 permeable to the liquid phase 23, and a sensor 28 located in the enclosure.

The antenna 24 is advantageously a broadband antenna, for example with a quality factor given by the inverse of the electromechanical coupling coefficient of the piezoelectric substrate the sensor is made of. The antenna 24 for example has a spiral shape and for example a S11 minimum ideally tuned in the band-pass of the sensor. The antenna 24 is electrically connected to the sensor 28 and adapted for converting the radar signal 20 into an input electrical signal 30 for the sensor. The antenna 24 is also adapted for converting an output electrical 32 signal from the sensor 28 into the response radar signal 22.

The enclosure 26 for example comprises a grid 34 adapted to let the liquid phase 23, including the BTEX component, flow into the enclosure.

The grid 34 is advantageously located in an upper part of the enclosure 26.

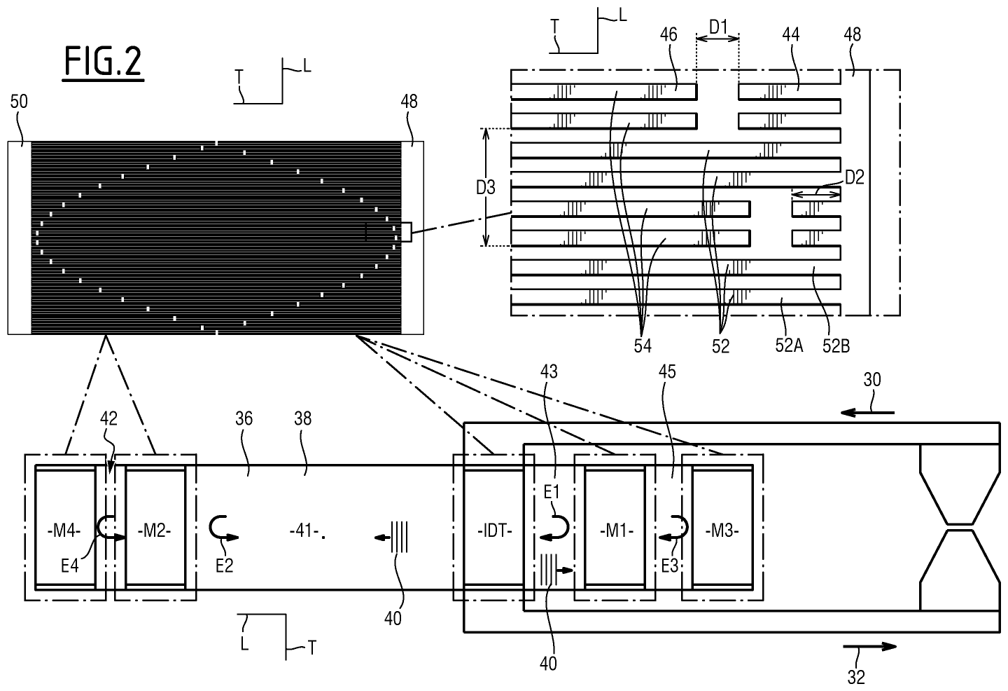

The sensor 28 (FIGS. 1 and 2) comprises a piezoelectric substrate 36 having a surface 38 extending in a longitudinal direction L, and an interdigitated transducer IDT located on the surface 38 and adapted to convert the input electrical signal 30 into surface acoustic waves 40 in the longitudinal direction L by piezoelectric effect. The sensor 28 comprises a first mirror M1 located on the surface 38 and adapted for receiving a first part of the surface acoustic waves 40 and for producing a first echo E1 towards the transducer IDT by mechanical reflection and/or re-emission of said first part of the surface acoustic waves. The sensor 28 also comprises a second mirror M2 located on the surface 38 and adapted for receiving a second part of the surface acoustic waves and producing a second echo E2 towards the transducer IDT by mechanical reflection or re-emission of said second part of the surface acoustic waves.

The sensor 28 comprises at least a first layer 41 of a first polymer located on the surface 38 between the transducer IDT and the second mirror M2, the first polymer being adapted to react with the BTEX component so as to modify a travel speed of the second echo E2 along the first layer 41.

The sensor 28 comprises at least a first guiding layer 43 comprising a metal and/or a polymer, the first guiding layer being located on the surface 38 between the transducer IDT and the first mirror M1.

In the example, the sensor 28 further comprises a third mirror M3 (only shown in FIG. 2) located on the surface 38 and adapted for receiving a third part of the surface acoustic waves 40 and producing a third echo E3 towards the transducer IDT by mechanical reflection and/or re-emission of said third part of the surface acoustic waves. The sensor 28 then comprises a second guiding layer 45 comprising a metal and/or a polymer, the second guiding layer being located on the surface 38 between the first mirror M1 and the third mirror M3.

Advantageously, the sensor 28 further comprises a fourth mirror M4 located on the surface 38 and adapted for receiving a fourth part of the surface acoustic waves and producing a fourth echo E4 towards the transducer IDT by mechanical reflection and/or re-emission of said a fourth part of the surface acoustic waves. The sensor 28 further comprises a second layer 42 of a second polymer located on the surface 38 between the transducer IDT and the fourth mirror M4, said second polymer being distinct from the first polymer and adapted to react with a chemical component in said liquid phase 23 so as to modify a travel speed of the fourth echo E4 along said second layer 42.

The sensor 28 is configured to form a reflective delay line, creating four echoes E1 to E4 in the example, the first echo E1 serving as a reference, the second echo E2 allowing to detect the BTEX component, the third echo E3 providing information about a drift due to temperature, and the fourth echo E4 allowing to detect the other chemical component. Depending on the number of mirrors and the nature of the layers on the surface 38 in between the mirrors and the transducer IDT, other configurations are possible for the sensor 28, some of which will be described later.

The sensor 28 is also configured so that the surface acoustic waves 40, along the first layer 41 of polymer and advantageously the second layer 42 of polymer, comprise Love waves. This allows maximizing energy confinement within the sensor 28, in order to maximize its gravimetric sensitivity.

The substrate 36 is made of stoechiometric lithium tantalate (LiTaO₃), for example YXI/36°, although any pseudo-shear wave generating crystallographic orientation (e.g. YXI/42°) will meet the requirements of a sensor operating in liquid.

The substrate 36 is adapted for propagating a pseudo-shear wave which can be confined to the surface 38 either by metalizing the free surface in order to slow down the wave and hence confine energy to the surface through the conducting boundary condition, and/or coating the surface with a polymer whose acoustic velocity is slower than the shear wave in the piezoelectric substrate bulk. This is performed by the first guiding layer 43 and the second guiding layer 45.

The substrate 36 is for example a rectangular plate, with a length of for example 10 mm in the longitudinal direction L, and a width of for example 3 mm in a transverse direction T perpendicular to the longitudinal direction L. The substrate 36 for example has a thickness comprised between 300 and 500 μm, thick enough to avoid interaction of the surface acoustic wave with the opposite side of the wafer.

In a particular embodiment, the transducer IDT, the first mirror M1, the second mirror M2, the third mirror M3 and the fourth mirror M4 are structurally analogous to each other.

For example, the first mirror M1 and the third mirror M3 (if present) are on one side of the transducer IDT in the longitudinal direction L, while the second mirror M2 and the fourth mirror M4 are on the other side. For example, the third mirror M3 is further away from the transducer IDT than the first mirror M1, and the fourth mirror M4 is further away from the transducer than the second mirror M2.

Advantageously, the mirrors are located along the longitudinal direction L so that the echoes they create are received successively by the transducer IDT and are easy to isolate from each other, with for example at least 0.5 μs between each other.

The transducer IDT is adapted to convert the first echo E1, the second echo E2, and advantageously the third echo E3 and the fourth echo E4, into the output electrical signal 32 by piezoelectric effect.

In the example, the transducer IDT, the first mirror M1, the second mirror M2, the third mirror M3 and the fourth mirror are structurally analogous to each other (though not represented in the same way in FIG. 1) since electrical re-emission is used as a reflection method rather than mechanical reflection at the low (sub-500 MHz) frequencies considered here. Therefore, only the transducer IDT will be described hereafter.

As a variant (not shown), the mirrors M1 to M4 may differ from the transducer IDT, and/or may differ from each other, for example by tuning the number of electrodes in each mirror so that the returned power is the same for all echoes.

The transducer IDT is advantageously formed by a single patterned layer of metal, for example aluminum, or gold if resistance to corrosion is desired.

The transducer IDT comprises two electrodes 44, 46 respectively comprising two bases 48, 50 extending longitudinally and spaced apart transversely from each other. The electrodes 44, 46 respectively comprise two sets of fingers 52, 54 protruding transversely from one of the bases 48, 50 towards the other one, and vice-versa.

The transducer IDT is interdigitated, as the fingers 52 from one set alternate with fingers 54 of the other set along a median line D parallel to the longitudinal direction L.

In the example, each of the fingers 52 of one of the two sets faces a corresponding finger 54 of the other set transversely.

The fingers 52, 54 are separated transversely by a distance D1 (FIG. 2) of for example 10 μm. The shortest fingers have a length D2 in the transverse direction T of for example 10 μm.

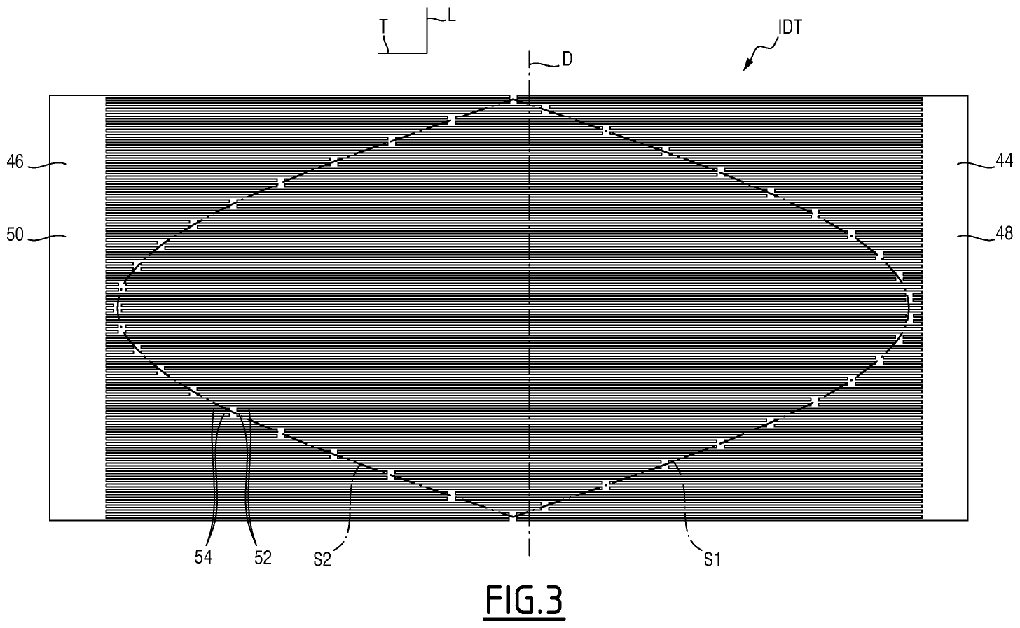

In the example shown in FIGS. 2 and 3, each of the fingers 52, 54 is a split finger. Each of the fingers is split in two half-fingers 52A, 52B. For example, the width of the half-fingers in the longitudinal direction L is equal to the distance between the half-fingers.

In the example, the transducer IDT has a sine shaped apodization, as, in each of the two sets of fingers 52, 54, one finger out of two in the longitudinal direction L defines a first portion of sinusoid S1, and the other finger out of two defines a second portion of sinusoid S2. Each of the first portion of sinusoid S1 and the second portion of sinusoid S2 for example corresponds to a half-period. The fingers forming the first portion of sinusoid S1 or the second portion of sinusoid S2 defines a longitudinal period D3 of for example 41 μm.

The fingers 52, 54 and the bases 48, 50 have a thickness, perpendicularly to the substrate 36, of for example 0.5 μm.

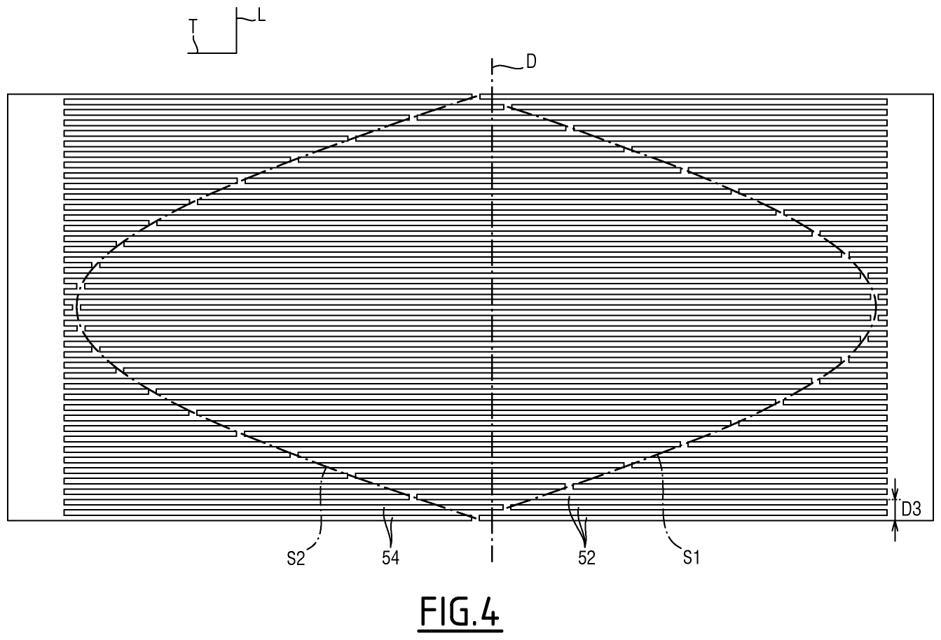

As a variant, shown in FIG. 4, the fingers 52, 54 are not split. The width of the fingers 52, 54 is for example equal to the distance between two consecutive fingers in the longitudinal direction L.

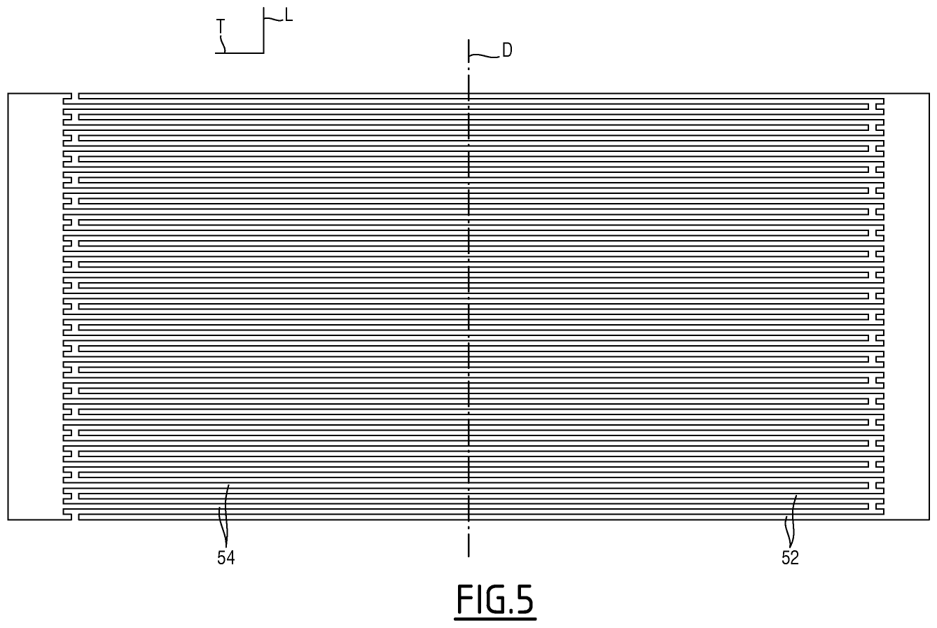

According to another variant, shown in FIG. 5, the transducer IDT has a simple apodization, as each of the sets of fingers 52, 54 includes long fingers and short fingers alternating longitudinally.

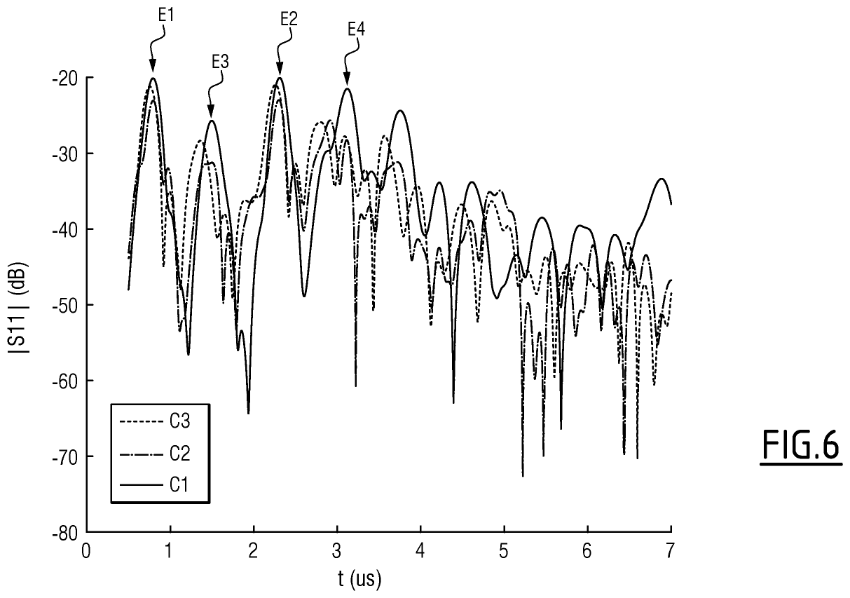

The impact of the various mirror architectures is shown in FIG. 6. FIG. 6 provides the time response (module of the reflection coefficient S11 in dB) of the sensor 28 with the transducer IDT and the four mirrors M1 to M4.

For curve C1, the transducer IDT and the four mirrors have the split finger and sine shaped apodization structure shown in FIG. 3. For curve C2, the transducer IDT and the four mirrors have the single finger and sine shaped apodization structure shown in FIG. 4. For curve C3, the transducer IDT and the four mirrors have the single finger and simple apodization structure shown in FIG. 5. The first, second, third and fourth echoes E1, E2, E3, E4 correspond to local maxima of the time domain response. As one can see on FIG. 6, the echoes are stronger with the split finger and sine shaped apodization structure.

The main mechanisms for transmitting a wave back from a mirror towards the IDT are mechanical reflection and re-emission. The former effect is induced by the acoustic velocity variation induced on the one hand by mechanical mass loading reflection and on the other hand by electrical boundary condition changes as the wave propagates from free space to an area metallized when patterning an electrode. It has been noticed that these two effects exhibit opposite sign in the case of a substrate in lithium niobate and add-up in the case of lithium tantalate. In re-emission, a current is induced in the mirror electrodes by the incoming acoustic wave, inducing stress in the crystalline lattice of the substrate 36 and hence a new acoustic wave propagating in both directions away from the mirror structure patterned as IDTs themselves. This was observed to yield the strongest echo and hence lowest insertion losses in the reflection coefficient.

The first polymer is for example poly (epichlorohydrin) (PECH).

The second polymer is for example polyisobutene (PIB).

The second polymer is preferably distinct from the first polymer. However, in a particular embodiment, the second polymer can be of the same nature as the first polymer, in order to assess the reproducibility of measurements.

In the example, the second layer 42 of the second polymer longitudinally extends only between the second mirror M2 and the fourth mirror M4.

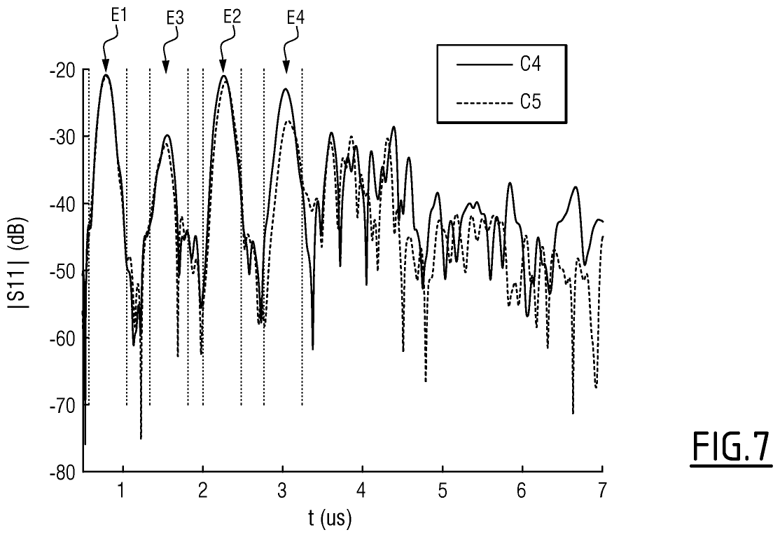

Coating the sensing areas between the transducer IDT and mirrors or between mirrors with soft polymers induces additional losses. The impact of these losses is shown in FIG. 7, where the response of the bare surface of the substrate 36 prior to being coated is exhibited in curve C4, and after coating with 900 nm-thick PECH layers in curve C5. Only half of the substrate 36 was coated using a selective lift-off processing technique, with the areas between IDT, mirrors M2 and M4 coated with the polymer inducing additional yet acceptable losses.

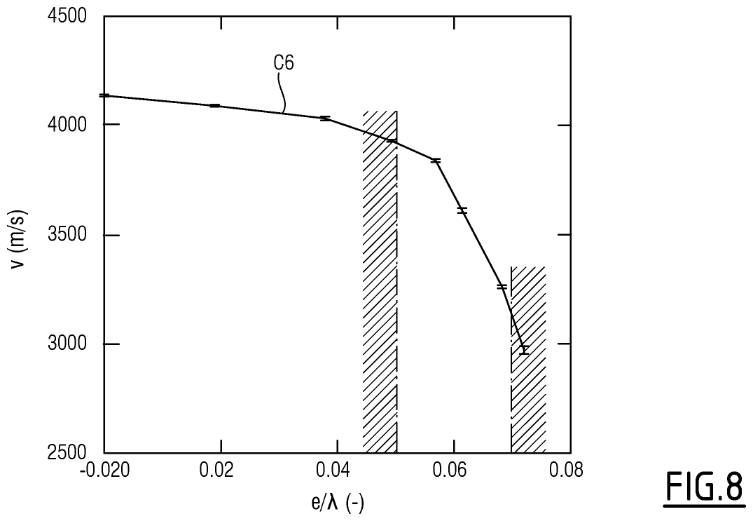

The polymer layer thickness e allows optimizing the gravimetric sensitivity through acoustic wave confinement in the polymer guiding the wave in a Love-mode approach. Various polymer dispersion curves were addressed to maximize the gravimetric sensitivity, measured as the slope of the acoustic wave velocity with respect to the polymer layer thickness e. For example, FIG. 8 shows the dispersion relation of S1813 novolak photoresist on YXI/36° LiTaO₃. The longitudinal velocity of acoustic waves along the layer of polymer is plotted as a function of the thickness e of the polymer layer divided by the wavelength λ of the acoustic waves. The larger the slope of this curve (in absolute value), the better the gravimetric sensitivity. As shown in FIG. 8, the slope starts becoming larger when e/λ is above 0.05. The absolute value of the slope then increases with e/λ. However, going further than 0.07 is not desirable, because the insertion losses will also increase.

As a result, it was determined that the layer 41, 42 of polymers should advantageously have a thickness e (perpendicularly to the longitudinal direction L and the transverse direction T) comprised between 2% and 7% of the wavelength λ of the acoustic waves along the layers of polymer.

The first guiding layer 43 is for example made of metal, a polymer, or a sub-layer of polymer on top of a sub-layer of metal lying on the surface 38.

The second guiding layer 45, if present, is also made of metal, a polymer, or a sub-layer of polymer on top of a sub-layer of metal lying on the surface 38.

The guiding layers are adapted for guiding and confining the acoustic waves and their echoes within the substrate 36.

The system 18 is configured so the radar signal 20 consists of a number of sequential oscillations or pulses 56, as visible in FIG. 1.

The system 18 is advantageously adapted for using the response radar signal 22 in order to detect the BTEX component.

As a variant, the system 18 is adapted to send the response radar signal 22 to a distant computer (not shown) adapted for using the response radar signal.

The number of sequential oscillations 56 is advantageously comprised between eight and twelve, in order to match the sensor transfer function, whose bandwidth is determined by the electromechanical coupling coefficient κ², with a preferred case being 1/κ²=10. The number of sequential oscillations 56 is for example ten.

However, in a particular embodiment, the radar signal 20 may comprise only one oscillation.

The frequency of the radar signal 20 is for example comprised between 100 and 500 MHz.

The operation of the installation 10 derives from its structure and will now be described in order to illustrate a method for detecting a sub-surface BTEX component according to the invention.

The aim is to detect the sub-surface BTEX component in the water-miscible or immiscible liquid phase in a soil 14 saturated with water.

For example, the radar signal 20 is emitted by the system 18. The radar signal 20 is received by the antenna which produces the input electrical signal 30.

The input electrical signal 30 is received by the transducer IDT and converted into the surface acoustic waves 40 in the longitudinal direction L.

The first part of the surface acoustic waves is received by the first mirror M1. The first mirror M1 produces the first echo E1 towards the interdigitated transducer IDT by mechanical reflection and/or re-emission of said first part of the surface acoustic waves. The first guiding layer 43 ensures that the first part of the surface acoustic waves and the first echo E1 can travel along the substrate 36.

The second part of the surface acoustic waves is received by the second mirror M2. The second mirror M2 produces the second echo E2 towards the transducer IDT by mechanical reflection or re-emission of said second part of the surface acoustic waves.

The enclosure 26 allows the liquid phase 23 surrounding the device 12 to be in contact with the first layer 41 of polymer. In case the BTEX component is present in the liquid phase 23, the BTEX component reacts with the first polymer and modifies the travel speed of acoustic waves along the first layer 41, which affects the second echo E2. The first layer 41 of polymer also ensures that the second part of the surface acoustic waves 40 and the second echo E2 can travel along the substrate 36.

The first echo E1 and the second echo E2 are converted by the interdigitated transducer IDT into at least part of the output electrical signal 32. The output electrical signal 32 is representative of the first echo E1 and second echo E2.

In the example, the output electrical signal 32 also contains information about the third echo E3 and the fourth echo E4. The fourth echo E4 may contain information about whether the second layer 42 of polymer has reacted with the other chemical component.

The first echo E1 serves as a time reference. The difference between the second echo E2 and the first echo E1 is representative of the presence of the BTEX component.

The difference between the third echo E3 and the first echo E1 is representative of an impact of temperature on the sensor 28. This difference may advantageously be used for correcting/improving the detection of the BTEX component.

The difference between the fourth echo E4 and the first echo E1 is advantageously representative of the detection of the other chemical component.

The output electrical signal 32 is converted by the antenna 24 into the response radar signal 22, which is then used in order to detect the BTEX component, and advantageously the other chemical component.

Thanks to the above features, the device 12 allows permanent detection of BTEX components in a liquid phase 23 that is difficult to access

### EXAMPLE

The sensor 28 was exposed to a continuous flow, first of pure water to stabilize the baseline, and then a water-toluene liquid phase, containing toluene concentrations varying from 0.052 to 0.52 g/L. The first layer 41 of polymer and the second layer 42 of polymer were 600 nm thick layer of PECH.

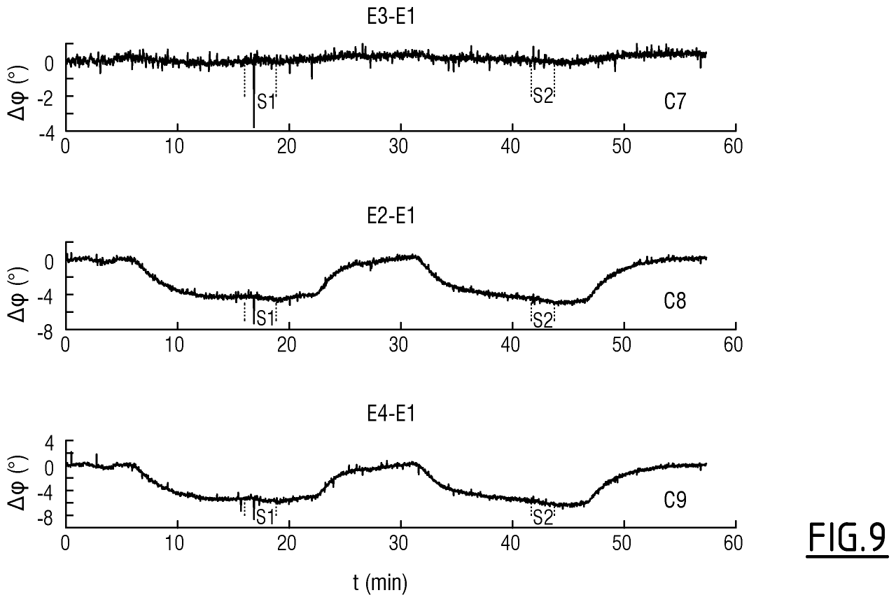

Results are shown in FIG. 9, where the differences between the third echo E3 and the first echo E1 (curve C7), between the second echo E2 and the first echo E1 (curve C8), and between the fourth echo E4 and the first echo E1 (curve C9) are expressed as a phase shift φ and represented versus time in minutes.

φ=2πfτ, where f is the sensor center frequency and τ the time delay of the echoes, with the differential measurement dφ=2πfdτ, with dτ the time delay difference between echoes used to get rid of the GPR to sensor range contribution of the phase.

The exposure was repeated multiple times to assess the reproducibility and reversibility of the reaction.

Because toluene is volatile and its low concentration in water might evolve over time, especially as the solution flows in the open pit liquid cell holding the SAW sensor, periodic analysis of the UV-Vis absorbance around 210 nm allowed for monitoring the toluene concentration in water. Hence, reproducibility of the response of the sensor is assessed not with respect to the nominal toluene concentration but to the measured toluene concentration which is observed not to evolve significantly between inlet and outlet but from one measurement to another.

The curves, particularly the difference between the second echo E2 and the first echo E1, demonstrates that the sensor 28 allows detecting the BTEX component, for example toluene.

In case there are only three mirrors, such as the mirrors M1, M2 and M4 shown in FIG. 1, the first layer 41 and the second layer 42 may be made of the same polymer with active sites sensitive to a BTEX component. The phase difference between the echo E4 (which is then a third echo) and the second echo E2 then allows getting rid of the influence of the distance between the system 18 and the sensor 28 and is representative of the presence of the BTEX component.

The first guiding layer 43 may be made of a different material, for example a metal or a polymer without active sites sensitive to the BTEX component. The phase difference between the echo E4 (or the second echo E2) and the first echo E1 then allows getting rid of an influence of the temperature.

As an alternative, the first guiding layer 43 may be made of a layer of polymer on top of a layer of metal.

As another variant, the first layer 41 and the second layer 42 may be made of different polymers with active sites sensitive to different BTEX components, in order to detect two components. The first guiding layer 43 may be made of one of the polymers, a metal, a polymer without active sites sensitive to the BTEX component, or a polymer on top of a metal.

In case there are four mirrors (as shown in FIG. 2), the presence of a fourth layer (such as the second guiding layer 45) made of a second polymer with active sites sensitive to another BTEX component provides an echo containing information representative of the presence of the other BTEX component. With four mirrors, it becomes possible to get rid of the influence of temperature and distance, and detect two BTEX components.

In the above examples, the layer(s) of polymers or metal and the guiding layer(s) are distributed in the zones between the IDT and the mirrors. What matters is their presence in all of these zones, not how they are distributed among these zones.

1. A device for wireless detection of a BTEX component in a soil saturated with water, the BTEX component and the water forming a liquid phase, the device comprising: an antenna adapted for receiving a radar signal and emitting a response radar signal; an enclosure permeable to the liquid phase; and a sensor located in the enclosure and comprising:
a piezoelectric substrate comprising lithium tantalate, the substrate having a surface extending in a longitudinal direction,
an interdigitated transducer located on the surface and electrically connected to the antenna for receiving an input electrical signal from the antenna and sending an output electrical signal to the antenna, the interdigitated transducer being adapted to convert the input electrical signal into surface acoustic waves in the longitudinal direction,
a first mirror located on the surface and adapted for receiving a first part of the surface acoustic waves and producing a first echo towards the interdigitated transducer by mechanical reflection and/or re-emission of said first part of the surface acoustic waves,
a second mirror located on the surface and adapted for receiving a second part of the surface acoustic waves and producing a second echo towards the transducer by mechanical reflection or re-emission of said second part of the surface acoustic waves,
at least a first layer of a first polymer located on the surface between the transducer and the second mirror, the first polymer being adapted for reacting with the BTEX component so as to modify a travel speed of the second echo along the first layer, and
at least a first guiding layer comprising a metal and/or a polymer, the first guiding layer being located on the surface between the transducer and the first mirror,
the interdigitated transducer being adapted to convert the first echo and the second echo into at least part of the output electrical signal,
the antenna being adapted for converting the output electrical signal into the response radar signal.

2. The device according to claim 1, wherein the sensor further comprises:
a third mirror located on the surface and adapted for receiving a third part of the surface acoustic waves and producing a third echo towards the transducer by mechanical reflection and/or re-emission of said third part of the surface acoustic waves, the transducer being adapted for receiving the third echo and converting the third echo into at least part of the output electrical signal, and
a second guiding layer comprising a metal and/or a polymer, the second guiding layer being located on the surface between the first mirror and the third mirror (M3).

3. The device according to claim 1, wherein the sensor further comprises:
a fourth mirror located on the surface and adapted for receiving a fourth part of the surface acoustic waves and producing a fourth echo towards the transducer by mechanical reflection and/or re-emission of said a fourth part of the surface acoustic waves, and
a second layer of a second polymer located on the surface between the transducer and the fourth mirror, said second polymer being distinct from the first polymer and adapted to react with a chemical component in said liquid phase so as to modify a travel speed of the fourth echo along said second layer,
the transducer being adapted for receiving the fourth echo and converting the fourth echo into at least part of the output electrical signal.

4. The device according to claim 1, wherein the sensor is configured so that said surface acoustic waves, first echo and second echo comprise Love waves.

5. The device according to claim 1, wherein the first polymer comprises poly(epichlorohydrin) or polyisobutene.

6. The device according to claim 1, wherein the device is devoid of any battery.

7. The device according to claim 1, wherein the transducer, the first mirror and the second mirror comprise aluminum.

8. The device according to claim 1, wherein one or several of the transducer, the first mirror and the second mirror are interdigitated transducer(s) having split-fingers extending in a transverse direction perpendicular to the longitudinal direction.

9. The device according to claim 1, wherein one or several of the transducer, the first mirror and the second mirror are interdigitated transducer(s) with sine shaped apodization.

10. The device according to claim 1, wherein the antenna is a broadband antenna.

11. The device according to claim 1, wherein the antenna has a spiral shape.

12. The device according to claim 1, wherein:
said transducer is configured to produce the surface acoustic waves along the first layer of polymer with a given wavelength, and
said first layer has a thickness perpendicularly to the longitudinal direction and the transverse direction, said thickness being comprised between 2% and 7% of said wavelength.

13. An installation comprising:
at least one device according to claim 1, intended to be buried in a soil at a distance from a surface of said soil; and
a system adapted for emitting said radar signal and for receiving said response radar signal, the system is being intended to be above said soil.

14. The installation according to claim 13, wherein:
said system is configured so that said radar signal includes a number of sequential oscillations,
said number is comprised between 8 and 12.

15. A method for detecting a BTEX component in a soil saturated with water, the water and the BTEX component forming a liquid phase, comprising the following steps:
obtaining a device according to claim 1 or an installation according to claim 13,
reception of a radar signal by the antenna and production of an input electrical signal,
reception by the transducer of the input electrical signal, and conversion of the input electrical signal into surface acoustic waves in the longitudinal direction,
reception by the first mirror of a first part of the surface acoustic waves and production of a first echo towards the interdigitated transducer by mechanical reflection and/or re-emission of said first part of the surface acoustic waves,
reception by the second mirror of a second part of the surface acoustic waves and production of a second echo towards the transducer by mechanical reflection or re-emission of said second part of the surface acoustic waves,
reaction of the first polymer with the BTEX component and modification of a travel speed of the second echo along the first layer,
conversion of the first echo and the second echo by the interdigitated transducer into at least part of an output electrical signal,
conversion by the antenna of the output electrical signal into a response radar signal, and
using the response radar signal in order to detect the BTEX component.
